(19) United States
(12) Patent Application Publication
(10) Pub. No.: US 2026/0181728 A1
(43) Pub. Date: Jun. 25, 2026

(54) METHOD AND APPARATUS FOR HANDLING NETWORK SLICE ACCESS GROUP (NSAG) INFORMATION

(71) Applicant: SAMSUNG ELECTRONICS CO., LTD., Suwon-si, Gyeonggi-do (KR)

(72) Inventors: Mahmoud WATFA, Staines, Middlesex (GB); Lalith KUMAR, Bangalore (IN)

(21) Appl. No.: 19/127,083

(22) PCT Filed: Nov. 2, 2023
(86) PCT No.: PCT/KR2023/017338

§ 371 Date: May 2, 2025

(30) Foreign Application Priority Data
Nov. 5, 2022 (IN) 202231063290
Oct. 6, 2023 (GB) 2315323.2

(51) Int. Cl. H04W 84/04; H04W 48/16; H04W 48/18; H04W 60/00; H04W 76/27; H04W 76/50; H04W 88/06

(52) U.S. Cl. CPC H04W 84/042; H04W 48/16; H04W 48/18; H04W 60/00; H04W 60/005; H04W 76/27; H04W 76/50; H04W 88/06

(57) ABSTRACT

The disclosure relates to a 5G or 6G communication system for supporting a higher data transmission rate. Disclosed is a method performed by a User Equipment, UE, in a telecommunication network, comprising the steps of: receiving, from a network entity, a Network Slice Access Group, NSAG, information; determining whether there is a Single-Network Slice Selection Assistance Information, S-NSSAI, entry which is in the NSAG information, which is not part of a configured NSSAI; and removing, from the NSAG information, any S-NSSAI entry which is in the NSAG information nad is not part of the configured NSSAI.

### TECHNICAL FIELD

The present invention relates to improvements in the management and operation of network slices. Such slices are known, particularly in Fifth Generation, 5G, telecommunication systems, but the teaching of this application may be applied in other systems also.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mm Wave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The purpose of this application is to be able to solve at least one of the drawbacks of the prior art.

The principal object of the embodiments herein is to provide a method and an apparatus for handling S-NSSAI in the NSAG, wherein the S-NSSAI is not part of configured NSSAI.

Another object of the embodiments herein is to prevent the UE using wrong resources or cells and prevent a congestion with other UEs which are allowed to use those resources.

### Solution to Problem

According to an embodiment of the present invention, a method performed by a user equipment, UE, is disclosed. The method includes receiving, from a network entity, Network Slice Access Group, NSAG, information; determining whether there is a Single-Network Slice Selection Assistance Information, S-NSSAI, entry which is in the NSAG information, which is not part of a configured NSSAI; and removing, from the NSAG information, any S-NSSAI entry which is in the NSAG information and is not part of the configured NSSAI.

According to another embodiment of the present invention, a user equipment, UE, in a telecommunication network is disclosed. The UE includes a transceiver and a controller, and the controller can be configured to receive, from a network entity, Network Slice Access Group, NSAG, information, determine whether there is a Single -Network Slice Selection Assistance Information, S-NSSAI, entry which is in the NSAG information, which is not part of a configured NSSAI, and remove, from the NSAG information, any S-NSSAI entry which is in the NSAG information and is not part of the configured NSSAI.

### Advantageous Effects of Invention

Embodiments of the present disclosure provides methods and apparatus for identifying S-NSSAIs in NSAG information which is not part of the configured NSSAI, and deleting the identified S-NSSAI.

Therefore, UEs can be prevented from using wrong resources or cells, and network congestion due to the wrong use of resources or cells can be prevented.

### BRIEF DESCRIPTION OF DRAWINGS

The method, the UE and the network apparatus in a wireless network are illustrated in the accompanying drawings, throughout which like reference letters indicate corresponding parts in the various figures. The embodiments herein will be better understood from the following description with reference to the drawings, in which:

FIG. 1 shows a flowchart illustrating an embodiment of the present invention.

FIG. 2 illustrates a structure of a UE in a wireless communication system according to an embodiment of the present disclosure.

FIG. 3 illustrates a structure of a network entity which performs a network function according to an embodiment of the present disclosure.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the one or more elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

A set of slices (known by the abbreviation S-NSSAI (Single-Network Slice Selection Assistance Information)) may be known to be part of a group, where the set of slices may be optionally valid with a set of Tracking Area Identities (TAIs), if available, and a certain priority level may also be associated with these slices and, hence, the group. If the list of TAIs is not available, then the slices are valid in the entire Public Land Mobile Network, PLMN. The following is an excerpt from section 4.6.2.6 of 3GPP TS 24.501 about Network Slice Access Group, NSAG:

“NSAG information provided by the network and stored in the UE includes a list of NSAGs each of which contains:
a) an NSAG ID;
b) a list of S-NSSAI(s), which are associated with the NSAG and shall be part of the configured NSSAI;
c) optionally a list of TAIs in which the NSAG is valid. If it is not provided by the network, the NSAG is valid in the PLMN which has sent the NSAG information; and
d) a priority value that is associated with the NSAG.

The UE NAS layer shall provide the lower layers with the most recent NSAG information stored in the UE (see subclause 4.6.2.2) to lower layers.

NOTE: Along with the NSAG information, the UE provides to the lower layers with allowed NSSAI and requested NSSAI for the purpose of NSAG-aware cell reselection.”

As set out in the above, the list of TAIs in the NSAG is optional.

Moreover, the list of S-NSSAIs of the NSAG must be part of the configured NSSAI. This means that there should not be any S-NSSAI in the NSAG information such that the S-NSSAI is not present in the configured NSSAI.

Regarding the configured NSSAI, it should be noted that the maximum number of slices that can be present in this list is 16 as stated in section 4.6.2.2 in 3GPP TS 24.501 V18.0.1:

“Each of the configured NSSAI stored in the UE is a set composed of at most 16 S-NSSAIs”However, if the UE actually receives more than 16 entries in the configured NSSAI, then the UE keeps the first 16 entries and deletes the rest as described in ‘Table 9.11.3.37.1: NSSAI information element’ of 3GPP TS 24.501 V 18.0.1:

“If the NSSAI information element conveys a configured NSSAI or pending NSSAI and more than 16 S-NSSAI values are included in this information element, the UE shall store the first 16 S-NSSAI values and ignore the remaining octets of the information element.”

From the above, it cannot therefore be ruled out that the UE may actually receive more than 16 entries for the configured NSSAI.

The following observation can be made from the above contents: the number of slices in the NSAG must not be more than the number of slices in the configured NSSAI. In other words, the number of slices in the configured NSSAI can be greater than those in the NSAG information but the opposite should not happen. Therefore, whenever there is NSAG information, it must be ensured and enforced that the slices in the NSAG must be part of the configured NSSAI.

There are various problems identified in the prior art.

Firstly, the UE may receive a number of S-NSSAIs in the NSAG information which is larger than the number of S-NSSAIs in the configured NSSAI. Just like the case referred to where the UE may receive more than 16 entries for the configured NSSAI even though only a maximum of 16 can be saved in the UE, it is then possible that the UE receives NSAG information such that the number of S-NSSAIs in this NSAG information exceeds the number of S-NSSAIs in the configured NSSAI. There is currently no provision made in the standard for handling this scenario. If not handled, then the outcome would be problematic for the reasons stated earlier.

Secondly, the UE may become registered for emergency services after having previously received NSAG information, hence performing unnecessary reselections.

The lower layers use NSAG information for cell reselection into TAIs which are associated with the NSAG group identifier of highest priority. However, all the principles and behaviours associated with the NSAG feature are supposed to be applicable to a UE which is registered with no restrictions and which is able to receive normal services. However, it is possible that a UE which was previously normally registered subsequently becomes registered for emergency services. In this case, the UE is considered to be only allowed access to emergency service, hence the term ‘registered for emergency services’. However, this is currently not the case i.e. the UE continues to use NSAG information even though the UE becomes registered for emergency services.

Thirdly, the UE may receive NSAG information with an invalid TAI. The UE may receive a TAI in the NSAG information such that the TAI is not part of the current registration area of the UE, or the TAI may be considered to be forbidden i.e. the TAI is part of the current forbidden TAI list that the UE already stores. How the UE behaves in this case is undefined and this may lead to unpredictable or inconsistent behaviour across different UEs in otherwise similar or identical conditions.

Fourthly, the network-specially the Access and Mobility management Function, AMF-AMF has no defined means to stop the UE from using NSAG. The specification (3GPP TS 24.501 V18.0.1) defines how the UE receives NSAG information and then uses it. However, if the network e.g. the AMF, determines that the UE should no longer use NSAG e.g. due to local policies or due to subscription changes, or any other decision taken by an entity in the 5G core network, then the AMF has no means of doing so.

It is an aim of embodiments of the present invention to address shortcomings in the prior art, whether mentioned herein or not.

According to the present invention there is provided an apparatus and method as set forth in the appended claims. Other features of the invention will be apparent from the dependent claims, and the description which follows.

According to a first aspect of the present invention, there is provided a method of operating a User Equipment, UE, arranged for communication with a telecommunication network, comprising the steps of:
the UE receiving Network Slice Access Group, NSAG, information from the telecommunication network;
the UE determining if there is a Single-Network Slice Selection Assistance Information, S-NSSAI, entry which is in the NSAG information, which is not part of a configured NSSAI; and
the UE removing any S-NSSAI entry which is in the NSAG information but not in the configured NSSAI.

In an embodiment, the NSAG is associated with a plurality of S-NSSAIs and a list of Tracking Area Identities, TAIs, and a priority value, wherein if the step of removing any S-NSSAI entry which is in the NSAG information but not in the configured NSSAI, results is no remaining S-NSSAI, then the UE deletes the NSAG information.

In an embodiment, the UE further deletes the list of TAIs and the priority values.

According to a second aspect of the present invention, there is provided an apparatus arranged to perform the method of the first aspect.

In an embodiment, the apparatus is a User Equipment arranged to communicate with the telecommunication network.

Although a few preferred embodiments of the present invention have been shown and described, it will be appreciated by those skilled in the art that various changes and modifications might be made without departing from the scope of the invention, as defined in the appended claims.

For a better understanding of the invention, and to show how embodiments of the same may be carried into effect, reference will now be made, by way of example only, to the accompanying diagrammatic drawings in which:

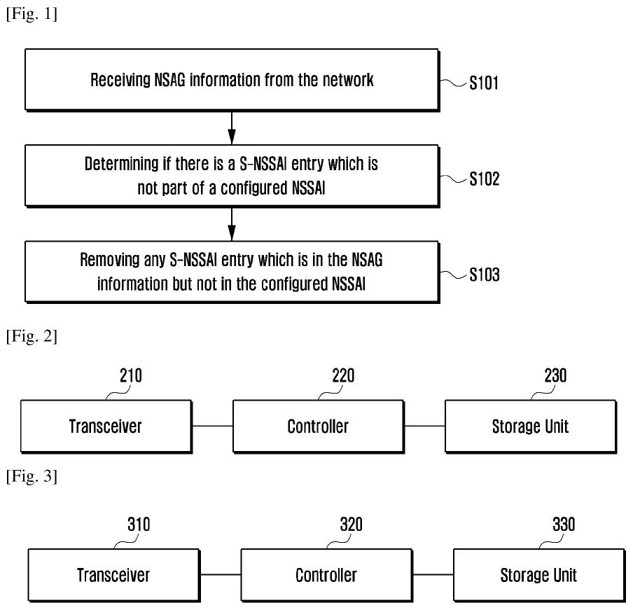

FIG. 1 shows a flowchart illustrating an embodiment of the present invention.

In an embodiment of the invention, the UE removes any S-NSSAI in the NSAG information which is not part of the configured NSSAI. In the case that the UE receives, or when the UE determines that, the NSAG information contains S-NSSAI which is not part of the configured NSSAI, then the UE should behave as follows:
If there is any S-NSSAI which is not part of the configured NSSAI, then the UE should delete the S-NSSAI; and
Optionally, if an NSAG e.g. a set of S-NSSAIs which are associated with a NSAG identifier and optionally a list of TAI and optionally a priority value, would contain no S-NSSAI after deleting any S-NSSAI which is not part of the configured NSSAI (as described above), then the UE may also delete the rest of the NSAG information i.e. the UE may delete the NSAG identifier, and optionally delete the TAI list if any, and optionally delete the NSAG priority value.

In other words, if the number of S-NSSAIs in the NSAG information is more than the number of S-NSSAIs in the configured NSSAI, then the UE should remove at least one S-NSSAI such that the total number of S-NSSAIs in the NSAG information does not exceed the number of S-NSSAIs in the configured NSSAI. The UE should always ensure that the slices or number of S-NSSAIs in the NSAG information does not exceed the number of slices or number of S-NSSAIs in the configured NSSAI.

Note that the process above is relevant for any number of S-NSSAIs in the configured NSSAI, even if the UE received a configured NSSAI for which the number of S-NSSAIs does not exceed 16.

FIG. 1 shows a flowchart illustrating the first embodiment. At S101, the UE receives a Network Slice Access Group, NSAG, information from the telecommunication network. At S102, the UE determines if there is a Single-Network Slice Selection Assistance Information, S-NSSAI, entry which is in the NSAG information, which is not part of a configured NSSAI. At S103, the UE removes any S-NSSAI entry which is in the NSAG information but not in the configured NSSAI.

In a second embodiment, The UE and/or the network stop(s) using NSAG when the UE has an emergency PDU session. A UE may be normally registered and may have received NSAG information. The UE may also have a PDU session for emergency services.

The UE, at any time, or regardless of its registration type, may receive a Configuration Update Command message with the 5GS registration result Information Element, IE, value set to “Registered for emergency services”. When this occurs, the UE may take any of the following actions:
The UE may behave as if NSAG is not supported by the UE
The UE may delete the NSAG information
The UE may inform the lower layers to stop using NSAG information
The UE may request the lower layers to delete the NSAG information and/or the allowed NSSAI and/or the requested NSSAI which the UE may have provided to the lower layers (optionally where this information may have been previously provided to the lower layers).

For a UE which has indicated that it supports NSAG (e.g. for a UE which had set the NSAG bit to “NSAG supported” in the 5GMM capability IE of the REGISTRATION REQUEST message), if the AMF sends the Configuration Update Command message with the 5GS registration result IE value to “Registered for emergency services”, then the AMF may behave as if NSAG information is not sent to the UE, or the AMF may behave as if the UE does not support NSAG information.

Note that the process above also applies for the case when the UE is normally registered but has established, or is attempting to establish, a PDU session for emergency services. Therefore, all the actions set out above also apply for the case when the UE is normally registered but has a PDU session for emergency services.

For example, if the UE and/or the network behave as if NSAG information is not supported when a UE has established a PDU session for emergency services (as set out earlier), then the UE and the network may consider that NSAG information is supported, and hence can be used, after the PDU session for emergency services is released or deactivated.

In another embodiment, when a UE is registering for emergency services, the UE which supports NSAG (information) should indicate in the 5GMM capability IE (of the Registration Request message) that NSAG is not supported. In other words, the UE should set the NSAG bit in the 5GMM capability IE to the value ‘NSAG not supported’ (i.e. value 0) even though the UE supports NSAG.

For a UE which is registering for emergency services, e.g. when the 5GS registration type IE indicates ‘emergency registration’, the AMF should not provide NSAG information to the UE even if the UE indicates that NSAG is supported in the 5GMM capability IE (of the Registration Request message).

In a further embodiment, a new UE behaviour is defined for handling NSAG information with a TAI that is either not part of the UE's registration area, or that is part of any forbidden TAI list.

If the UE receives NSAG information where any TAI, which is part of the NSAG information, is not part of the UE's current registration area (i.e. not part of the of 5GS TAIs that the UE received from the network), then the UE should take any one or more of the following actions in any combination:
The UE should remove/delete from the NSAG information any TAI(s) which is (are) in the NSAG information but which is (are) not part of the UE's registration area
The UE should remove/delete the NSAG information associated with that TAI i.e. the slices, NSAG identifier and priority, if any of these are available, which are associated with the TAI in question. In other words, the UE need not delete the entire NSAG information but rather the parameters that are associated with the TAI in question i.e. the TAI which is not part of the UE's registration area.

If the UE receives NSAG information where any TAI, which is part of the NSAG information, is also present in either the list of “5GS forbidden tracking areas for roaming” or the list of “5GS forbidden tracking areas for regional provision of service”, then the UE may take one or more of the following actions:
The UE may behave as stated above i.e. remove the TAI (and optionally any related parameter which is associated with this TAI) from the NSAG information (i.e. the UE may take the same behaviour as described above for the case when a TAI in the NSAG information is not part of the UE's registration area)
The UE may remove the TAI from the list of “5GS forbidden tracking areas for roaming” or from the list of “5GS forbidden tracking areas for regional provision of service”.

In a further embodiment, new AMF behaviour is defined to revoke (or start) the use of NSAG information.

The AMF may decide to revoke the use of NSAG information for a UE which supports NSAG (i.e. for a UE which had indicated that NSAG is supported in the 5GMM capability IE of the Registration Request message) and/or optionally for a UE for which the AMF had previously provided NSAG information.

Note that the decision to revoke or stop the use of NSAG for a UE may be based on the following determination in the AMF:
Local policies that determine that NSAG should no longer be used (optionally for a UE in question)
Change of subscription information indicating that NSAG should no longer be used (optionally for a UE in question)
Indication from any other network entity (either new or existing) such that NSAG should no longer be used (optionally for a UE in question)

To stop or revoke the use of NSAG information for this UE, the AMF may take one or more of the following actions:
The AMF should send the Configuration Update Command and include the NSAG information IE where the IE is set to include empty contents
   For example, empty content of the IE may be achieved by setting the length field (i.e. the “Length of NSAG information contents” field) of the NSAG information IE to zero
The AMF should send the Configured NSSAI IE in the Configuration Update Command message but without including the NSAG information IE in the message
   Note that in this case, the contents of the Configured NSSAI IE need not be new S-NSSAIs and may indeed be the same (or possibly partly new) S-NSSAIs which the AMF may have previously provided to the UE, or may be exactly the same set of S-NSSAIs that the AMF has previously provided to the UE, or may be partly new or totally new
The AMF should trigger a registration procedure for the UE using the current NAS connection i.e. without the UE entering into 5GMM-IDLE mode. The AMF can do so by setting the “registration requested” in the Registration requested bit of the Configuration update indication IE and “release of N1 NAS signalling connection not required” in the Signalling connection maintain request bit of the Additional configuration indication IE in the CONFIGURATION UPDATE COMMAND message. Furthermore, during the registration procedure that follows, the AMF should send the Configured NSSAI IE in the Registration Accept message, but the message should not include the NSAG information IE.

For any of the actions above that lead the UE to receiving a Configured NSSAI IE but not the NSAG information IE, this will lead the UE to delete the NSAG information and hence the UE cannot use NSAG anymore.

Note that for a UE which supports NSAG (e.g. the UE indicates that NSAG is supported in the 5GMM capability IE of the Registration Request message), the AMF may use the same mechanisms above to enforce the use of NSAG or to start the use of NSAG in the UE. The determination to do so may be similar to the events listed above e.g. local policies, subscription change, etc, such that the AMF now determines that NSAG should be used. The AMF may send the Configuration Update Command message and include the NSAG information IE optionally with the configured NSSAI, when the AMF determines to allow the use of NSAG at the UE. Alternatively, the AMF can trigger a registration procedure for the UE, while still in connected mode i.e. without entering idle mode and while using the current NAS connection (as described above), and during the registration procedure the AMF may provide the NSAG information IE in the Registration Accept message, optionally with a configured NSSAI as well.

The AMF may also determine to provide NSAG information to the UE, which is already registered, when another network function provides an indication to do so.

FIG. 2 illustrate a structure of a UE in a wireless communication system according to an embodiment of the present disclosure.

Referring to FIG. 2, a user equipment, UE, may include a transceiver 210, a controller 220, and a storage unit 230. In the present disclosure, the controller may be defined as a circuit, an application-specific integrated circuit, or at least one processor.

The transceiver 210 may transmit or receive a signal to or from other network entities. For example, the transceiver 210 may transmit or receive a signal or a message to or from an AMF which is a network entity which manages access to an access network and mobility of a UE.

The controller 220 may control an overall operation of a UE such that the UE can operate according to embodiments proposed in the present disclosure. For example, the controller 220 may control a signal flow between blocks so as to perform an operation according to the above-described flowchart.

The storage unit 230 may store at least one of information transmitted or received via the transceiver 210 and information generated via the controller 220.

FIG. 3 illustrates a structure of a network entity which performs a network function according to an embodiment of the present disclosure.

A network entity of FIG. 3 may be one of the AMF, SMF, UPF, NSSF, AF, NEF or other entity of the network.

Referring to FIG. 3, the network entity which performs a network function may include a transceiver 310, a controller 320, and a storage unit 330. In the present disclosure, the controller may be defined as a circuit, an application-specific integrated circuit, or at least one processor.

The transceiver 310 may transmit or receive a signal to or from other network entities. For example, the transceiver 310 may transmit or receive a signal or a message to or from an AMF which is a network entity which manages access to an access network and mobility of a UE.

The controller 320 may control an overall operation of a network entity which performs a network function according to the embodiments proposed in the present disclosure. For example, the controller 320 may control a signal flow between blocks so as to perform an operation according to the above-described flowchart.

The storage unit 330 may store at least one of information transmitted or received via the transceiver 310 and information generated via the controller 320.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method performed by a User Equipment, UE, in a telecommunication network, the method comprising:
receiving, from a network entity, Network Slice Access Group, NSAG, information;
determining whether there is a Single-Network Slice Selection Assistance Information, S-NSSAI, entry which is in the NSAG information, which is not part of a configured NSSAI; and
removing, from the NSAG information, any S-NSSAI entry which is in the NSAG information and is not part of the configured NSSAI.

2. The method of claim 1,
wherein the NSAG information is associated with a plurality of S-NSSAIs, a list of Tracking Area Identities, TAIs, and a priority value.

3. The method of claim 2, further comprising:
in case that there is no remaining S-NSSAI as a result of the removing any S-NSSAI entry which is in the NSAG information but not in the configured NSSAI, deleting the NSAG information.

4. The method of claim 3, further comprising:
deleting the list of TAIs and the priority value.

5. The method of claim 1, further comprising:
in case that a number of S-NSSAIs in the NSAG information is more than a number of S-NSAAI in the configured NSSAI, removing at least one S-NSSAIs in the NSAG information.

6. The method of claim 1, further comprising:
in case that the UE has established PDU session for emergency service, deleting the NSAG information.

7. The method of claim 1, further comprising:
in case that a TAI in the NSAG information is not part of a current registration area of the UE, removing any TAI, from the NSAG information, which is in the NSAG information and is not part of the current registration area of the UE.

8. A User Equipment, UE, in a telecommunication network, the UE comprising:
a transceiver; and
a controller configured to:
receive, from a network entity, Network Slice Access Group, NSAG, information,
determine whether there is a Single-Network Slice Selection Assistance Information, S-NSSAI, entry which is in the NSAG information, which is not part of a configured NSSAI, and remove, from the NSAG information, any S-NSSAI entry which is in the NSAG information and is not part of the configured NSSAI.

9. The UE of claim 8,
wherein the NSAG information is associated with a plurality of S-NSSAIs, a list of Tracking Area Identities, TAIs, and a priority value.

10. The UE of claim 9,
wherein the controller is further configured to:
in case that there is no remaining S-NSSAI as a result of the removing any S-NSSAI entry which is in the NSAG information but not in the configured NSSAI, delete the NSAG information.

11. The UE of claim 10,
wherein the controller is further configured to:
delete the list of TAIs and the priority value.

12. The UE of claim 8,
wherein the controller is further configured to:
in case that a number of S-NSSAIs in the NSAG information is more than a number of S-NSAAI in the configured NSSAI, remove at least one S-NSSAIs in the NSAG information.

13. The UE of claim 8,
wherein the controller is further configured to:
in case that the UE has established PDU session for emergency service, delete the NSAG information.

14. The UE of claim 8,
wherein the controller is further configured to:
in case that a TAI in the NSAG information is not part of a current registration area of the UE, remove any TAI, from the NSAG information, which is in the NSAG information and is not part of the current registration area of the UE.
